(19) United States
(12) Patent Application Publication
(10) Pub. No.: US 2014/0156787 A1
(43) Pub. Date: Jun. 5, 2014

(54) VIRTUAL WALL FOR WRITINGS ASSOCIATED WITH LANDMARKS

(71) Applicant: YAHOO! INC., Sunnyvale, CA (US)

(72) Inventor: Saurabh SRIVASTAVA, Bangalore (IN)

(73) Assignee: YAHOO! INC., Sunnyvale, CA (US)

(21) Appl. No.: 13/705,786

(22) Filed: Dec. 5, 2012

(51) Int. Cl. H04L 29/08

(52) U.S. Cl. CPC H04L 29/08072
USPC 709/217

(57) ABSTRACT

The present invention provides techniques that allow a user to generate an image of a landmark, which can be a famous location, monument, etc., which image includes written comments added by the user. The comments may appear to be on or partially on the landmark. The comments may express sentiment of the user associated with or inspired by the landmark, similar to inscriptions or graffiti, but allowing the user to express such sentiments without altering or defacing the landmark itself. Techniques are also provided in which another user or users can add additional comments to the image, which can then be shared with other users, or selectively shared with certain users or friends. Techniques are also provided in which users can generate or utilize a virtual wall or virtual surface, which may at least partially be visibly in front of the landmark, on which to write comments.

### BACKGROUND

People are often strongly motivated to write or inscribe on real world objects, such as landmarks, monuments, famous locations, locations of great natural beauty, etc. For example, a person may wish to express his or her emotions or sentiments upon beholding the landmark, such as for others or friends to see, appreciate, comment on in return in a similar fashion, etc. It may, for example, be important to the writer that the writing by intimately associated with the landmark. Unfortunately, however, writings or inscriptions on landmarks may deface the landmark, restricting people from expressing themselves in the desired fashion.

### SUMMARY

Some embodiments of the invention provide systems and methods that include allowing a user to generate an image of a landmark, which can be a famous location, monument, etc., and which image includes written comments added by the user. The comments may appear to be on or partially on the landmark. The comments may express sentiment of the user associated with or inspired by the landmark, similar to inscriptions or graffiti, but allowing the user to express such sentiments without altering or defacing the landmark itself. Techniques are also provided in which another user or users can add additional comments to the image, which can then be shared with other users, or selectively shared with certain users or friends. Techniques are also provided in which users can generate or utilize a conceptual virtual wall or virtual surface, which may at least partially be visibly in front of the landmark, on which to write comments.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention;

FIG. 5 is a flow diagram illustrating a method according to one embodiment of the invention;

FIG. 6 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

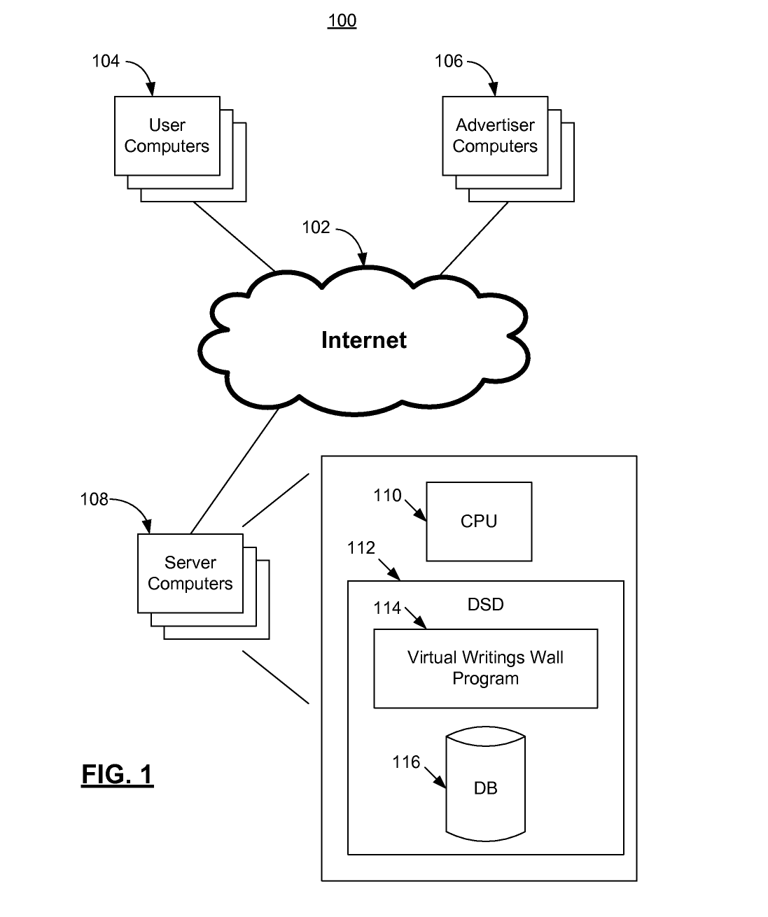

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and a Virtual Writings Wall Program 114.

The Program 114 is intended to broadly include all programming, applications, algorithms, software, engines, modules, functions, and other tools necessary to implement or facilitate methods and systems according to embodiments of the invention. The elements of the Program 114 may exist on a single server computer or be distributed among multiple computers or devices.

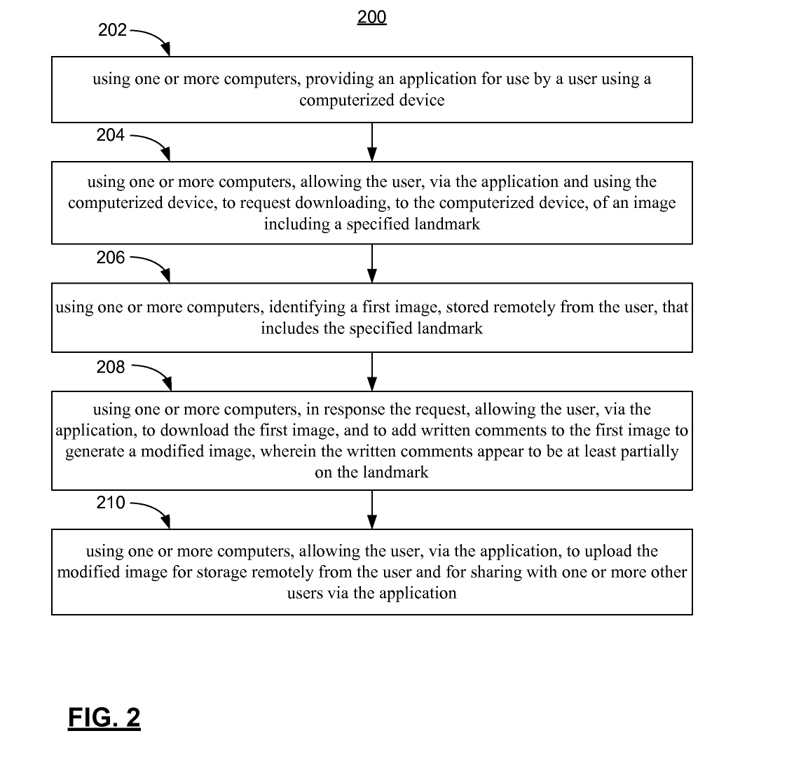

FIG. 2 is a flow diagram illustrating a method 200 according to one embodiment of the invention. Step 202 includes, using one or more computers, providing an application for use by a user using a computerized device.

Step 204 includes, using one or more computers, allowing the user, via the application and using the computerized device, to request downloading, to the computerized device, of an image including a specified landmark.

Step 206 includes, using one or more computers, identifying a first image, stored remotely from the user, that includes the specified landmark.

Step 208 includes, using one or more computers, in response the request, allowing the user, via the application, to download the first image, and to add written comments to the first image to generate a modified image, in which the written comments appear to be at least partially on the landmark.

Step 210 includes, using one or more computers, allowing the user, via the application, to upload the modified image for storage remotely from the user and for sharing with one or more other users via the application.

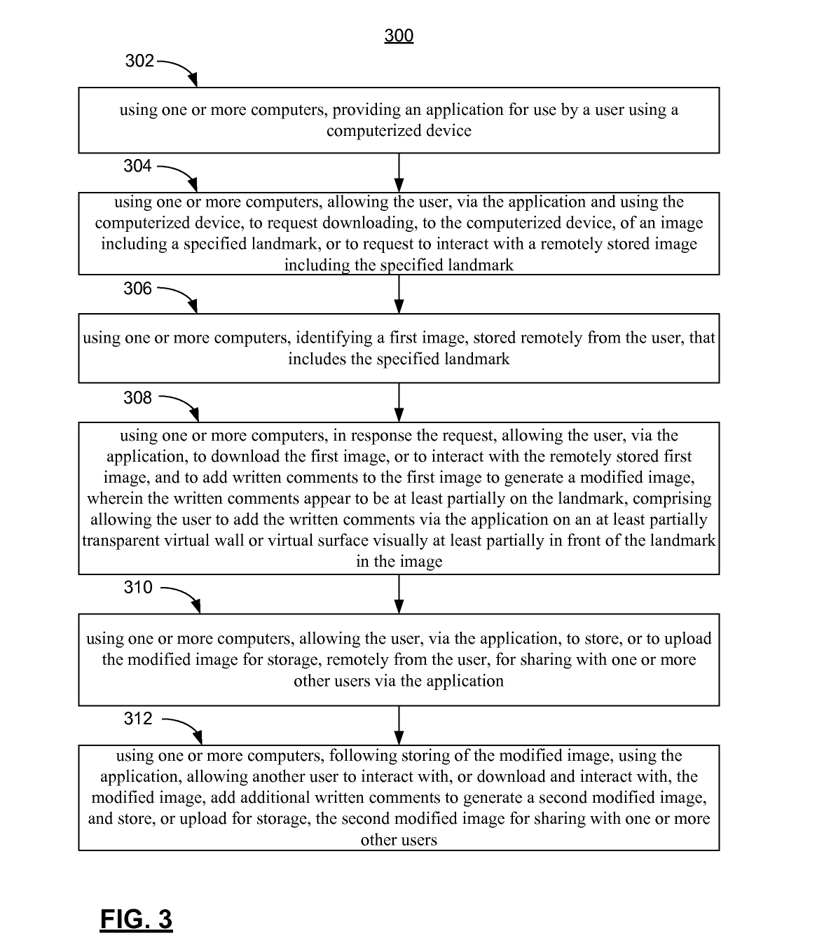

FIG. 3 is a flow diagram illustrating a method 300 according to one embodiment of the invention. Step 302 includes, using one or more computers, providing an application for use by a user using a computerized device.

Step 304 includes, using one or more computers, allowing the user, via the application and using the computerized device, to request (even if not explicit) downloading, to the computerized device, of an image including a specified landmark, or to request to interact with a remotely stored image including the specified landmark.

Step 306 includes, using one or more computers, identifying a first image, stored remotely from the user, that includes the specified landmark.

Step 308 includes, using one or more computers, in response the request, allowing the user, via the application, to download the first image, or to interact with the remotely stored first image, and to add written comments to the first image to generate a modified image, wherein the written comments appear to be at least partially on the landmark. The user is allowed to add the written comments via the application on an at least partially transparent virtual wall or virtual surface visually at least partially in front of the landmark in the image.

Step 310 includes, using one or more computers, allowing the user, via the application, to store, or to upload the modified image for storage, remotely from the user, for sharing with one or more other users via the application.

Step 312 includes, using one or more computers, following storing of the modified image, using the application, allowing another user to interact with, or download and interact with, the modified image, add additional written comments to generate a second modified image, and store, or upload for storage, the second modified image for sharing with one or more other users.

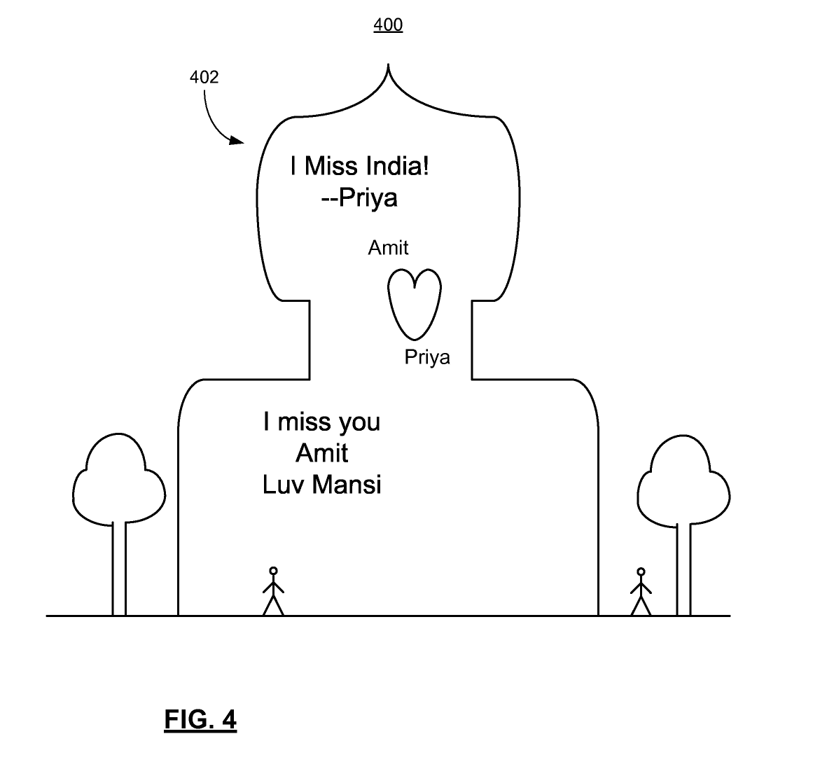

FIG. 4 is a block diagram 400 illustrating one embodiment of the invention. Specifically, FIG. 4 depicts an example of an image including a landmark, and including added user writings. As depicted, the landmark is a famous building in India. As further depicted, over time, users have added writings, which may be conceived as added to a virtual wall in front of the building. The writings may, for example, be sentimental, and be associated in some way with the landmark or what the landmark represents to the user. For example, some writings may express that a user misses a location represented or symbolized by the landmark. Another user may be inspired to express sentiment toward another user in the setting created by the landmark image. Of course, many other examples are possible.

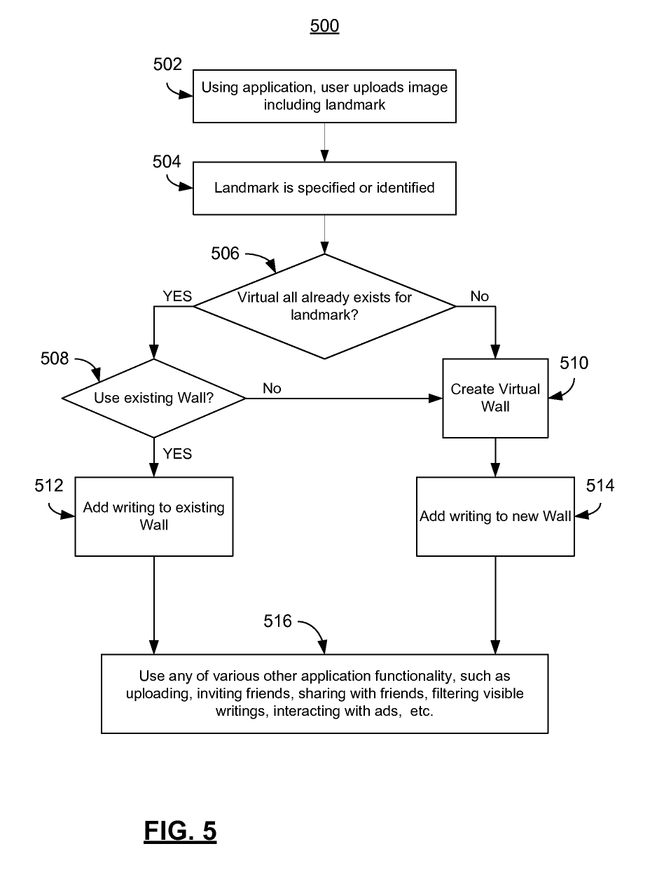

FIG. 5 is a flow diagram illustrating a method 500 one embodiment of the invention. At step 502, using an application, a user uploads an image including a landmark.

At step 504, the landmark is specified or identified.

At step 506, it is queried whether a virtual wall already exists for the landmark. If “yes”, then the method 500 proceeds to 508, where it is queried whether the user wishes to use the existing wall. If yes, then the method proceeds to step 512, at which the user can add one or more writings to the existing wall.

If the answer is “no” at step 506, then, at step 510, a virtual wall is created, which can include creating an image including the landmark and on which writings can be added by the user, and then, at step 514, the user can add one or more writings to the new Wall.

Following step 512 or step 514, at step 516, the user may use any of various other application functionality, such as uploading, inviting friends, sharing with friends, filtering visible writings, interacting with ads, etc.

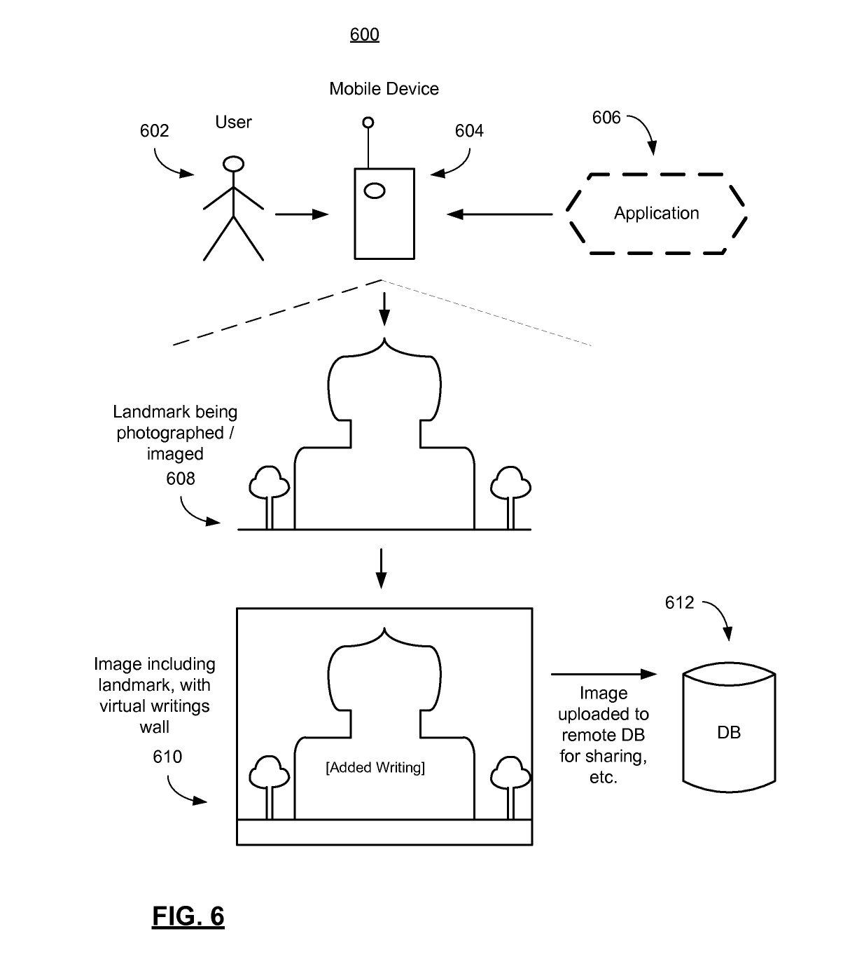

FIG. 6 is a block diagram 600 illustrating one embodiment of the invention. A user 602 is depicted, utilizing a mobile device 604, such as a smart phone, through which the user uses and interacts with an application 606, whether on the smart phone itself after downloading the application, or by interacting with the application remotely, such as via the Internet.

Block 608 represents a landmark being photographed or otherwise imaged, such as using the mobile device 604.

Block 610 represents an image including the landmark, and including a virtual writings wall, which virtual wall can be purely conceptual in nature. As depicted, one or more writings may then be added to the image.

Block 612 represents a database, remote from the user, to which a modified version of the image, including one or more added writings, can be stored, such as for sharing with other users, access and interaction by other users, etc. However, in some embodiments, the modified image may be stored locally.

Some embodiments of the invention allow a user to add writings, such as sentimental comments, visibly in association with a landmark, which can broadly include a famous or popular location, object, monument, natural scene, etc. In some embodiments, the comments can appear to be actually on, or partially on, the landmark in the image, which can give the effect of actual inscriptions or graffiti on the landmark.

In some embodiments, an application is provided to the user, to facilitate or allow aspects relating to the image, the writings, and other functionality such as sharing with other users or interacting with advertisements.

In some embodiments, the application may be downloaded and utilized on a device of the user, such as a desktop computer, or a mobile device such as a smart phone, tablet computer, notebook computer, or other device, or multiple devices. In some embodiments, the application may be accessed, such as wirelessly, via the Internet, so the application and images are stored remotely and interacted with remotely.

In some embodiments, via the application, the user can upload an image including a landmark, such as a photograph or other image taken, in various possible forms such as pdf, tiff, etc., by the mobile device of the user. For example, this may occur while the user is travelling or on vacation, and impacted emotionally by a landmark. The landmark may be specifically identified in words by the user, or image recognition may be used, locally or remotely, or location may be used, or some combination, to identify the landmark for the user.

Via the application, locally or remotely, the user may be provided with an image including the landmark, with which the user can interact (which can include one-way interaction), such as to add writing (and potentially symbols, drawings, etc.) directly to the image. Furthermore, in some embodiments, even video or audio clips may be associated with the image.

In some embodiments, a conceptual virtual wall or virtual surface, which may be semi-transparent, transparent, or framed, may be envisioned as generated utilizing the application, and to be in front of the landmark. It may be on this virtual wall that comments are envisioned as being placed.

In some embodiments, utilizing the application, the user can select various characteristics or conditions associated with the writing. For example, the user may be able to select the placement of the writing on the image, framing or shape, color or font. The user may also be able to select from or draw symbols or other non-letter based writing or graffiti. In some embodiments, the user can do this in real time, such as while the user is physically visiting the landmark and may be most inspired.

In some embodiments, in a manner analogous to actual inscriptions or graffiti, multiple users may add writings to an image, such as at different times. For example, a user may store an image including a landmark with a writing added by the user. A second user may then access the image, add his or her own writings as well, and store that. The same type of process may occur for a third user, etc. As a result, the image may come to contain many writings by many users.

In some embodiments, friends or social group members may utilize a particular image for writings. For example, the application may allow only certain contacts to access to the image, or to add writings to it. In some embodiments, friends or social contacts may include messages intended for other friends or social contacts, such as expressions of nostalgia, missing someone, love, etc.

In some embodiments, if a user accesses an image that may contain writings by multiple users, the user can filter the writings that the user actually sees. For example, the user may select to see only writings by friends or social contacts of the user, or some other filtering criteria, etc. In such cases, the application may provide an image that appears to include only the selected-for writings, with other writings, perhaps only temporarily, not appearing at all.

In some embodiments, advertisements may be targeting, such as while the user is using the application or in the process of viewing writings or adding a writing. For instance, an advertisement may be selected based on a combination of criteria that may include the landmark, a location or other topics associated with the landmark, a writing by the user on the landmark or topic associated with the writing, writings of other users or other users who are contacts of the user or who reference the user in their writings on the landmark, etc. For example, such advertisements may appear actually on or partially on the landmark or a virtual wall, or may be served while other elements of the image are obscured, may be displayed in connection with particular writings or particular elements of the landmark or image, may be displayed in an area of a display separate from the image, etc. In some embodiments, advertising and interacting with advertising may be incorporated or integrated with the application. For example, in some embodiments, users may agree to receive or interact with advertisements for free items, such as free use of the application, for discounts, coupons, rewards or other compensation, for access to added features or functionality from the application, etc.

Some embodiments utilize a concept which can give a user a new unique way to, for example, select, write or scribble writings relating to emotions, sentimental expressions and feelings on, for example, famous landmarks, such as monuments, etc. In some embodiments, for example, a user or users can keep the real physical beauty of the landmark alive by creating a virtual wall in front of or around it (which can mean simply allowing writing as if on a flat transparent surface in front of or on the landmark), such as in real time, perhaps virtually leaving that scribble on that landmark indefinitely. In some embodiments, users can doodle on a landmark in real time, or online remote from the site, and share with friends. A user may also be able to give comments or suggestions on other doodles, such as those of the user's friends. An entity, such as a Web portal, which may be providing the application that the user uses, can then use the information obtained, including the user-generated content of the writings, and the landmarks themselves or associated information, to select or target highly relevant advertisements to users, leading to high levels of engagement, click through rates, interaction, actions, conversion rates, return on investment for advertisers, etc.

Some embodiments essentially create a set of virtual landmarks or locations, creating a virtual world and leading to various monetization opportunities in the virtual world, such as by advertising within the virtual world and using information about users and their interaction and communication within the virtual world.

Some embodiments include a mobile device application, or “app”, which user can carry anywhere and anytime. In some embodiments, the user may use a camera on a mobile device to focus on or take an image or picture of a landmark on which the user would like to write. Through the application, the system may immediately look up and inform the user of any or all present images, virtual walls, other doodles, etc. The user may be allowed to add his or her doodle on an existing image, or to can create his or her own, and perhaps share the image with his or her friends. In some embodiments, such as using GPS systems in mobile devices, landmarks and locations will be determined and stored, such as by latitude and longitude tagging. This can, for example, allow others who may visit the location to be informed of the images, access them, add writings to them, etc.

An example of use of one embodiment of the invention follows. A smart phone user visits or returns to India and visits the Taj Mahal. The user is moved by the landmark, and desires to leave a sentimental writing. Using an application, such as a virtual wall application, the user uses his smart phone to take a picture or obtain an image of the landmark. The image is uploaded to a remote server, where image recognition, or location coordinates, or both, are used to determine that the landmark is the Taj Mahal. If an image allowing writing, which can be viewed as a virtual wall, exists for the landmark, then the user may write on it, perhaps along with writings of other users. If not, or if the user prefers to create his own virtual wall, then the user may create one.

For example, the user mentioned above may decide to write “I miss India” on the virtual wall for the Taj Mahal, including deciding on characteristics of the writing including placement, font, color, etc.

The user may also, for example, use filtering to filter the writings that are shown on the virtual wall. For example, filters may relate to filtering for writings by friends or social group members only, or various other parameters such as specific names, geographic associations, expression type or mood associations, weather or climate associations, etc.

Furthermore, one or more advertisements may be served to the user, such as via the application, for example, while the user is accessing or interacting with the virtual wall. Such advertisements may be displayed on the virtual wall, beside it, etc.

While the invention is described with reference to the above drawings, the drawings are intended to be illustrative, and the invention contemplates other embodiments within the spirit of the invention.

1. A method comprising:
using one or more computers, providing an application for use by a user using a computerized device;
using one or more computers, allowing the user, via the application and using the computerized device, to request downloading to the computerized device of an image including a specified landmark;
using one or more computers, identifying a first image, stored remotely from the user, that includes the specified landmark;
using one or more computers, in response the request, allowing the user, via the application, to download the first image, and to add written comments to the first image to generate a modified image, wherein the written comments appear to be at least partially on the landmark; and
using one or more computers, allowing the user, via the application, to upload the modified image for storage remotely from the user and for sharing with one or more other users via the application.

2. The method of claim 1, comprising, prior to the downloading, allowing the user to upload the first image for storage remotely from the user.

3. The method of claim 1, comprising, following the uploading of the modified image, using the application, allowing another user to download the modified image, add additional written comments to generate a second modified image, and upload the second modified image for sharing with one or more other users.

4. The method of claim 1, wherein the landmark is specified at least in part by uploading an image including the landmark so that the landmark can be identified at least in part utilizing an image recognition technique.

5. The method of claim 1, comprising allowing the user to download the application via the Internet for use using the computerized device.

6. The method of claim 1, comprising allowing the user to access and utilize the application via the Internet, wherein the application is executed remotely from the user.

7. The method of claim 1, wherein the computerized device is a mobile device.

8. The method of claim 1, wherein the computerized device is a tablet computer.

9. The method of claim 1, wherein the computerized device is a smart phone.

10. The method of claim 1, wherein the written comments express sentiment of the user associated with the landmark or a location represented or symbolized by the landmark.

11. The method of claim 1, wherein the landmark is a monument, famous object or famous location.

12. The method of claim 1, comprising allowing the user to add the written comments via the application on an at least partially transparent virtual wall or virtual surface visually at least partially in front of the landmark in the image.

13. The method of claim 1, comprising targeting the user with an advertisement based at least in part on the landmark, or a location associated with the landmark, and based at least in part on the written comments.

14. The method of claim 1, comprising, using the application, allowing the user to view written comments of other users in association with the landmark, and comprising allowing the user to filter the written comments of the other users so that only a subset of all of the written comments of the other users are visible.

15. A system comprising:
one or more server computers coupled to a network; and
one or more databases coupled to the one or more server computers;
wherein the one or more server computers are for:
providing an application for use by a user using a computerized device;
allowing the user, via the application and using the computerized device, to request to interact with a remotely stored image including a specified landmark;
identifying a first image, stored remotely from the user, that includes the specified landmark;
in response the request, allowing the user, via the application, to interact with the first image, and to add written comments to the first image to generate a modified image, wherein the written comments appear to be at least partially on the landmark; and
allowing the user, via the application, to store the modified image remotely from the user, for sharing with one or more other users via the application.

16. The system of claim 15, wherein at least one of the one or more server computers are coupled to the Internet.

17. The system of claim 15, wherein the image is stored in at least one of the one or more databases.

18. The system of claim 15, comprising targeting the user with an advertisement based at least in part on the landmark, or a location associated with the landmark, and based at least in part on the written comments.

19. The system of claim 15, comprising, following the storing of the modified image, using the application, allowing another user to interact with the modified, add additional written comments to generate a second modified image, and to store the second modified image for sharing with one or more other users.

20. A computer readable medium or media containing instructions for executing a method comprising:
using one or more computers, providing an application for use by a user using a computerized device;
using one or more computers, allowing the user, via the application and using the computerized device, to request downloading, to the computerized device, of an image including a specified landmark;
using one or more computers, identifying a first image, stored remotely from the user, that includes the specified landmark;
using one or more computers, in response the request, allowing the user, via the application, to download the first image, and to add written comments to the first image to generate a modified image, wherein the written comments appear to be at least partially on the landmark, comprising allowing the user to add the written comments via the application on an at least partially transparent virtual wall or virtual surface visually at least partially in front of the landmark in the image;
using one or more computers, allowing the user, via the application, to upload the modified image for storage remotely from the user and for sharing with one or more other users via the application; and
using one or more computers, following the uploading of the modified image, using the application, allowing another user to download the modified image, add additional written comments to generate a second modified image, and upload the second modified image for sharing with one or more other users.
